(19) United States
(12) Patent Application Publication
(10) Pub. No.: US 2023/0153037 A1
(43) Pub. Date: May 18, 2023

(54) System and Method for a Storage Controller Card with Redundant Boot Storage

(71) Applicant: Microchip Technology Incorporated, Chandler, AZ (US)

(72) Inventor: Deepak Shekar, Malur (IN)

(73) Assignee: Microchip Technology Incorporated, Chandler, AZ (US)

(21) Appl. No.: 17/724,728

(22) Filed: Apr. 20, 2022

(30) Foreign Application Priority Data
Nov. 17, 2021 (IN) 202111052758

(51) Int. Cl. G06F 3/06

(52) U.S. Cl. CPC G06F 3/0689; G06F 3/0659; G06F 3/064; G06F 3/0623

(57) ABSTRACT

An storage controller and method for providing a respective first and a second solid-state memory interface to control a first and a second flash memory, a RAID controller coupled to the first and second solid-state memory interface, the RAID controller presenting a single boot device to a CPU and synchronizing writes to made to the boot device to both of the first and second solid-state memories, the RAID controller providing a plurality of data storage ports to be coupled to at least three data storage drives wherein the RAID controller is to present a unified data device to the CPU.

### PRIORITY

The present application claims priority to Indian Patent Application No. 202111052758 filed Nov. 17, 2021, the contents of which are hereby incorporated in their entirety.

### FIELD OF THE INVENTION

The present application relates to drive controllers in a computing system.

### BACKGROUND

Computer servers, also known as blades, provide limited physical space for data storage but have demanding requirements for the same.

### SUMMARY

In some examples, a storage controller card is provided with a first and a second storage drive onboard the storage controller card and a storage processor in communication with each of first and second onboard storage drives. The storage processor comprising a RAID controller, the RAID controller presenting a single boot device to a CPU, the single boot device comprising data stored on each of the first and second onboard storage drives as a mirrored set of storage drives, the RAID controller synchronizing writes made to the boot device to both of the first and second onboard storage drives so that the data on each of the first and second onboard storage drives are identical. In certain examples, the storage controller card comprises a plurality of data storage ports, each of the plurality of data storage ports responsive to the storage processor. In certain examples, the storage controller card comprises a plurality of data storage ports, each of the plurality of data storage ports responsive to the RAID controller, so that the RAID controller provide redundancy through the data storage ports of one of RAID level 0, 1, 10, 5, 50, 6 or 60. In certain examples, in response to a read request addressed to the single boot device, the RAID controller reads data from only one of the of the first and second onboard storage drives and returns the read data. In certain examples, the first and second first and second onboard storage drives are each one of a M.2 NVMe, SD, SDHC, or SDXC memory card. In certain examples, the storage controller card is a PCIe x16 expansion card. In certain examples, the storage processor comprises an encryption engine coupled to the RAID controller to encrypt data to be written to the first and second onboard storage drives and decrypt data read from either of the first and second onboard storage drives.

In some examples, a method is provided comprising providing a storage controller card having a storage processor, a first onboard storage drive and a second onboard storage drive, the storage processor comprising a RAID controller. The method includes receiving at the storage controller card a command to write a block of data targeting a logical address in a boot volume. The method includes writing the block of data to each of the first onboard storage drive and the second onboard storage drive. In certain examples, the method includes encrypting the block of data, wherein the writing the block of data to each of the first onboard storage drive and the second onboard storage drive is of the encrypted block of data. In certain examples, the method includes receiving at the storage controller a command to read the block of data targeting the logical address in the boot volume, reading the encrypted block of data from only one of the first onboard storage drive and the second onboard storage drive, decrypting the block of data, and returning the block of data.

In some examples, a server is provided including a central processor unit (CPU); a boot read only memory; and a storage controller card, the storage controller card comprising a first and a second onboard storage drive and a storage processor, the storage processor comprising a RAID controller, the RAID controller presenting a single boot device to the CPU, the single boot device comprising data stored on each of the first and second onboard storage drives as a mirrored set of storage drives, the RAID controller synchronizing writes made to the boot device to both of the first and second solid-state memories so that the data on each of the first and second storage onboard drives are identical. In certain examples, the storage controller card comprises a plurality of data storage ports, each of the plurality of data storage ports responsive to the storage processor. In certain examples, the storage controller card comprises a plurality of data storage ports, each of the plurality of data storage ports responsive to the RAID controller, so that the RAID controller provide redundancy through the data storage ports of one of RAID level 0, 1, 10, 5, 50, 6, or 60. In certain examples, in response to a read request from the CPU addressed to the single boot device, the RAID controller reads data from only one of the of the first and second onboard storage drives, and returns the read data to the CPU. In certain examples, the first and second first and second onboard storage drives are each one of a M.2 NVMe, SD, SDHC, or SDXC memory card. In certain examples, the storage controller card is a PCIe x16 expansion card. In certain examples, the storage processor comprises an encryption engine coupled to the RAID controller to encrypt data to be written to the first and second onboard storage drives and decrypt data read from either of the first and second onboard storage drives.

### BRIEF DESCRIPTION OF THE DRAWINGS

FIG. 1 is an illustration of a server system, according to examples of the present disclosure.

FIG. 2 a diagram of a storage controller card with onboard storage drives, according to certain examples of the present disclosure.

FIG. 3 is a flowchart of a method for using a storage controller expansion card, according to certain examples of the present disclosure.

### DETAILED DESCRIPTION

FIG. 1 is an illustration of a server system, according to examples of the present disclosure. Server 100 is a rack-mounted server in a 1U form factor. Server 100 includes printed circuit board (PCB) motherboard 101. Motherboard 101 includes central processing unit (CPU) 102, random access memory (RAM) slots 104, and peripheral component interconnect express (PCI-e) slot 106. Storage controller card 108 is a PCI-e x16 expansion card seated in slot 106 and in communication with CPU 102 and memory in RAM slots 104 via the PCI-e bus. Storage controller card 108 includes first and second onboard storage drives 124a, 124b. Storage controller card 108 includes multiple storage interface ports 110. Storage interface ports 110 may support a standard storage interface protocol such as SATA or SAS over a suitable cable 112. Storage interface ports 110 may be universal backplane ports (UBP). Server 100 may also include space for multiple drives 114a-114d. In some examples, any of drives 114a-114d may be a hard disk, a solid-state drive (SSD), or a hybrid drive incorporating both a hard disk and an SSD. Drives 114a and 114b are in one example hot-swappable and may be removed and replaced while server 100 is operating.

Server 100 requires storage of operating system software and configuration options in a traditional filesystem. Server 100 is designed to maximize user data capacity within the limited capacity of the server enclosure (e.g., physical space, power capacity, and thermal capacity). Drives 114 are preferably dedicated to data storage and need not contain storage for the operating system or application software. Drives 114 are in one example organized for redundant access for performance and/or reliability using RAID level 0, 1, 10, 5, 50, 6 or 60. For example, redundancy of RAID Level 5 (or RAID Level 6) requires at least three drives (four for RAID 6) clustered into a data storage volume. RAID 5/6 stripes data and one or two parity bits across multiple drives to form a RAID volume. Stated differently, to read data from a RAID 5/6 volume at least three drives must be online and error free. A RAID 5 volume can survive a single drive failure whereas a RAID 6 volume can survive two drive failures. Once a failed drive is replaced, the RAID controller must rebuild the data on the replacement drive (or drives) and this rebuilding process temporarily impacts performance. RAID Levels 5 and 6 provide fast read times, slow write times and redundancy. In many scenarios RAID 5/6 capabilities align with the user workload (e.g., a database server or web server). In contrast, RAID Level 1 mirrors data between two drives providing two identical images of the data. RAID Level 1 provides balanced read/write performance.

In contrast, the system workload placed on a boot device does not align well with the performance levels of RAID 5/6 or the need to have multiple drives online and error free to read from the volume. When a server first powers on (or restarts), the CPU of the server accesses a specialized memory called a boot ROM 103 which stores just enough software to instruct the CPU of the server to communicate with a boot device and load a predetermined file (often a second-level bootloader or an operating system kernel) from the boot device. Preferably the boot ROM does not contain complex driver software, e.g., a RAID controller driver. In addition to a second level bootloader or kernel, the boot device generally stores operating system software, user programs, configuration data, swap space, and filesystem caches (collectively, System Data) that is preferably organized in a file system with high read and write performance. The boot device should have high availability because the server cannot function without the boot device. The boot device is preferably encrypted to prevent unauthorized access to sensitive data such as login data, configuration data, and cache data. Encryption also prevents certain types of attacks by malicious actors.

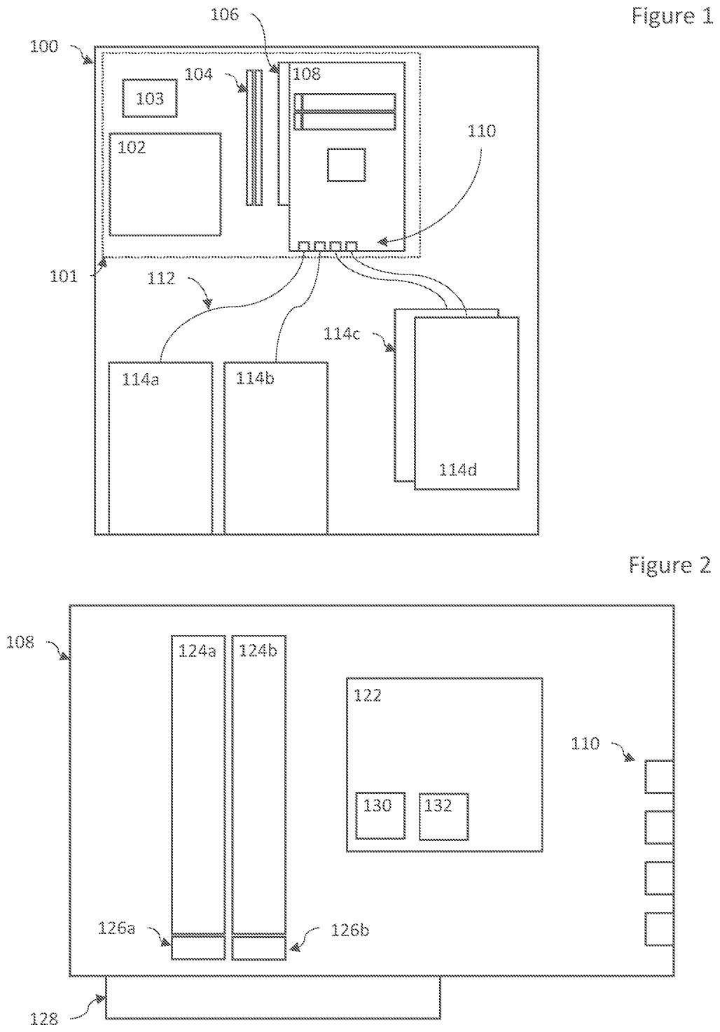

FIG. 2 a diagram of a storage controller card 108 with onboard storage drives, according to certain examples of the present disclosure, which acts as the boot device. Storage controller card 108 is a printed circuit board configured to be a PCI-e card with card edge connector 128. Storage controller card 108 includes storage processor 122, first and second onboard storage drives 124a, 124b, storage card connectors 126a and 126b, and storage ports 110. Storage card connectors 126a, 126b provide a respective electrical connection between first and second onboard storage drives 124a, 124b and storage processor 122, and as a result storage processor 122 is in communication with each first and second onboard storage drives 124a, 124b. In some examples, first and second onboard storage drives 124a, 124b are M.2 NVMe drives. In some examples, first and second onboard storage drives 124a, 124b are SD/SDHC/SDXC cards. First and second onboard storage drives 124a, 124b may be flash memory drives, which are compact and provide sufficient storage with acceptable power and thermal performance. Storage processor 122 includes redundant array of inexpensive disks (RAID) controller 130. RAID controller 130 synchronizes writes (and erases) to first and second onboard storage drives 124a, 124b to keep both synchronized as a single boot volume. RAID controller 130 may also provide RAID services for data drives 114 connected to storage interface ports 110. In some examples, RAID controller 130 may support 1,024 drives housed in the enclosure of server 100 or in one or more drive enclosures external to server 100. RAID controller 130 also identifies any hardware or data errors and logs or reports the same to the operating system. In the event of an error, RAID controller 130 may discontinue synchronizing first and second onboard storage drives 124a, 124b and treat the known-good onboard storage drive as an ordinary device until the device that generated an error is replaced or repaired. Storage processor 122 optionally includes encryption engine 132. Encryption engine 132 encrypts data written to the first and second onboard storage drives 124a, 124b and decrypts data read from first and second onboard storage drives 124a, 124b. In some examples, encryption engine 132 may interface with a trusted platform module on motherboard 101 to obtain encryption credentials during startup.

Storage controller card 108 may include one or more heat sinks (not shown) to manage heat produced by RAID controller 130 and first and second onboard storage drives 124a, and 124b. In some examples, heat sinks may cover most of storage controller card 108. As indicated above, storage controller card 108 acts as the boot device for CPU 102, and, by virtue of raid controller 130, presents a single storage device to CPU 102, i.e., CPU 102 does not address first and second onboard storage drives 124a, 124b as separate drives. Instead, CPU 102 sees them as a single drive, with a capacity equal to a capacity of the smaller of first and second onboard storage drives 124a, 124b. There is no requirement that the capacities of first and second onboard storage drives 124a, 124b be different, and they may be of the same capacity.

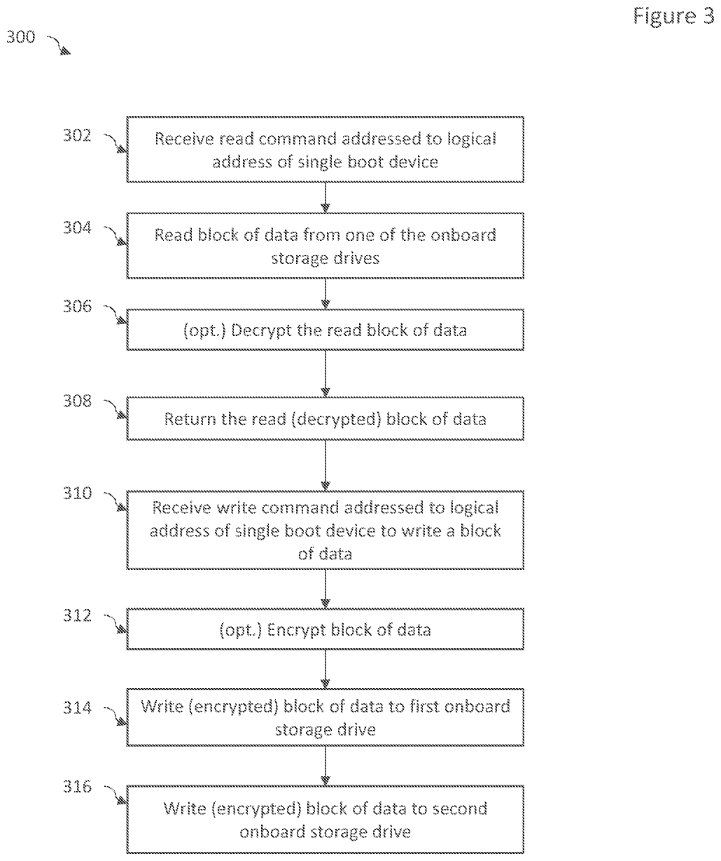

FIG. 3 is a flowchart of a method for using a storage controller card with onboard storage drives, according to certain examples of the present disclosure. Method 300 begins at block 302 wherein storage controller card 108 receives a read command, which may be from CPU 102 to read a block of data from a logical address of a single boot device. At block 304, RAID controller 130 of storage controller card 108 reads the block of data from one of the first and second onboard storage drives. In one example, storage controller card 108 reads the block of data from only one of the first and second onboard storage drives. At block 306, which is optional, the read block of data is decrypted by encryption engine 132. At block 308, the read block of data, optionally decrypted, is returned to the CPU.

At block 310, storage controller card 108 receives a write comment addressed to a logical address of the single boot device, the command to write a block of data. At block 312, which is optional, storage processor 122 encrypts the block of data using optional encryption engine 132 to protect against snooping and to centralize encryption key management within the storage controller card 108. At block 314, RAID controller 130 writes the optionally encrypted block of data to first onboard storage drive 124a. At block 316, RAID controller 130 writes the optionally encrypted block of data to second onboard storage drive 124b to ensure data in onboard storage drives 124a and 124b 124a and 124b are identical. As a result, the single boot device comprises data stored on each of the first and second onboard storage drives as a mirrored set of storage drives, with RAID controller 130 synchronizing writes made to the boot device to both of the first and second onboard storage drives so that the data on each of the first and second onboard storage drives are identical.

Although example embodiments have been described above, other variations and embodiments may be made from this disclosure without departing from the spirit and scope of these embodiments.

What is claimed is:

1. A storage controller card, comprising:
a first and a second storage drive onboard the storage controller card;
a storage processor in communication with each of first and second onboard storage drives, the storage processor comprising a RAID controller, the RAID controller presenting a single boot device to a CPU, the single boot device comprising data stored on each of the first and second onboard storage drives as a mirrored set of storage drives, the RAID controller synchronizing writes made to the boot device to both of the first and second onboard storage drives so that the data on each of the first and second onboard storage drives are identical.

2. The storage controller card of claim 1, comprising a plurality of data storage ports, each of the plurality of data storage ports responsive to the storage processor.

3. The storage controller card of claim 1, comprising a plurality of data storage ports, each of the plurality of data storage ports responsive to the RAID controller, so that the RAID controller provide redundancy through the data storage ports of one of RAID level 0, 1, 10, 5, 50, 6 or 60.

4. The storage controller card of claim 1, wherein in response to a read request addressed to the single boot device, the RAID controller reads data from only one of the of the first and second onboard storage drives and returns the read data.

5. The storage controller card of claim 1, wherein the first and second first and second onboard storage drives are each one of a M.2 NVMe, SD, SDHC, or SDXC memory card.

6. The storage controller card of claim 1, wherein the storage controller card is a PCIe x16 expansion card.

7. The storage controller card of claim 1, wherein the storage processor comprises an encryption engine coupled to the RAID controller to encrypt data to be written to the first and second onboard storage drives and decrypt data read from either of the first and second onboard storage drives.

8. A method comprising:
providing a storage controller card having a storage processor, a first onboard storage drive and a second onboard storage drive, the storage processor comprising a RAID controller;
receiving at the storage controller card a command to write a block of data targeting a logical address in a boot volume,
writing the block of data to each of the first onboard storage drive and the second onboard storage drive.

9. The method of claim 8, comprising encrypting the block of data, wherein the writing the block of data to each of the first onboard storage drive and the second onboard storage drive is of the encrypted block of data.

10. The method of claim 9, comprising
receiving at the storage controller a command to read the block of data targeting the logical address in the boot volume,
reading the encrypted block of data from only one of the first onboard storage drive and the second onboard storage drive,
decrypting the block of data, and
returning the block of data.

11. A server, comprising:
a central processor unit (CPU);
a boot read only memory; and
a storage controller card, the storage controller card comprising a first and a second onboard storage drive and a storage processor, the storage processor comprising a RAID controller, the RAID controller presenting a single boot device to the CPU, the single boot device comprising data stored on each of the first and second onboard storage drives as a mirrored set of storage drives, the RAID controller synchronizing writes made to the boot device to both of the first and second solid-state memories so that the data on each of the first and second storage onboard drives are identical.

12. The server of claim 11, wherein the storage controller card comprises a plurality of data storage ports, each of the plurality of data storage ports responsive to the storage processor.

13. The server of claim 11, wherein the storage controller card comprises a plurality of data storage ports, each of the plurality of data storage ports responsive to the RAID controller, so that the RAID controller provide redundancy through the data storage ports of one of RAID level 0, 1, 10, 5, 50, 6, or 60.

14. The server of claim 11, wherein in response to a read request from the CPU addressed to the single boot device, the RAID controller reads data from only one of the of the first and second onboard storage drives, and returns the read data to the CPU.

15. The server of claim 11, wherein the first and second first and second onboard storage drives are each one of a M.2 NVMe, SD, SDHC, or SDXC memory card.

16. The server of claim 11, wherein the storage controller card is a PCIe x16 expansion card.

17. The server of claim 11, wherein the storage processor comprises an encryption engine coupled to the RAID controller to encrypt data to be written to the first and second onboard storage drives and decrypt data read from either of the first and second onboard storage drives.
